(19) United States
(12) Patent Application Publication
(10) Pub. No.: US 2025/0289496 A1
(43) Pub. Date: Sep. 18, 2025

(54) VEHICLE CONTROL SYSTEM, NON-TRANSITORY COMPUTER READABLE STORAGE MEDIUM AND VEHICLE CONTROL METHOD

(71) Applicants: DENSO CORPORATION, Kariya-city (JP); J-QuAD DYNAMICS Inc., Tokyo (JP); ADVICS CO., LTD., Kariya-city (JP); AISIN CORPORATION, Kariya-shi (JP); JTEKT CORPORATION, Kariya-shi (JP)

(72) Inventor: Daisuke NAGASAKA, Tokyo (JP)

(21) Appl. No.: 19/073,126

(22) Filed: Mar. 7, 2025

(30) Foreign Application Priority Data
Mar. 14, 2024 (JP) 2024-040156

(51) Int. Cl. B62D 6/00

(52) U.S. Cl. CPC B62D 6/002

(57) ABSTRACT

A vehicle control system controls a yaw motion of a vehicle generated by an operation of an input unit in a steering system of the vehicle. A yaw motion control unit acquires information on a vehicle speed of the vehicle, an operable range of the input unit by a driver of the vehicle, and an operation amount of the input unit, calculates an addition amount that is to be added to the operation amount according to the operable range, and outputs a calculated addition amount to the steering system.

### CROSS REFERENCE TO RELATED APPLICATION

The present application claims the benefit of priority from Japanese Patent Application No. 2024-040156 filed on Mar. 14, 2024. The entire disclosure of the above application is incorporated herein by reference.

### TECHNICAL FIELD

The present disclosure relates to a vehicle control system, a non-transitory computer readable storage medium, and a vehicle control method used to control the yaw motion of a vehicle.

### BACKGROUND ART

In recent years, a vehicle control system that electromechanically controls a steering actuator in a vehicle such as an automobile has become known. For example, the vehicle control system according to a conceivable technique electromechanically adjusts the turning angle of at least one wheel set of a vehicle to control the yaw motion of the vehicle.

Here, the yaw motion is a rotational motion of a vehicle about a vertical axis that occurs due to a steering operation by a driver while the vehicle is traveling, and is also defined as “yaw,” “yawing,” or “yawing motion.”

### SUMMARY OF INVENTION

According to an example, a vehicle control system controls a yaw motion of a vehicle generated by an operation of an input unit in a steering system of the vehicle. A yaw motion control unit acquires information on a vehicle speed of the vehicle, an operable range of the input unit by a driver of the vehicle, and an operation amount of the input unit, calculates an addition amount that is to be added to the operation amount according to the operable range, and outputs a calculated addition amount to the steering system.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of a vehicle on which a vehicle control system according to an embodiment is mounted;

FIG. 2 is an explanatory diagram of an outline of a process in the vehicle control system according to the embodiment;

FIG. 3 is a block diagram showing an example of the configuration of an addition value calculation unit; and

FIG. 4 is a flowchart showing an example of a processing operation of the vehicle control system for controlling a yaw motion of the subject vehicle.

### DETAILED DESCRIPTION

Now, in the case where a driver of a vehicle has physical limitations due to various reasons such as an upper limb disability or an injury or illness, the amount of operation of an input device used for steering operation, such as a steering wheel, may be limited. The vehicle control system according to a conceivable technique does not take into account cases where the driver has limited steering ability, and is therefore unable to deal with such situations. Therefore, in order to be able to appropriately control the yaw motion of a vehicle when there are physical limitations of the driver, it is conceivable to design the input device for steering operation itself to suit the physical limitations, for example, according to another conceivable technique.

However, if the steering input device itself is designed to suit physical limitations, the vehicle cockpit would need to be modified, making it difficult to share the cockpit with a driver without physical limitations.

In view of the above, the present embodiments aims to provide a vehicle control system and a vehicle control program that enable appropriate control of the yaw motion of a vehicle regardless of the physical conditions of each individual driver, without adding auxiliary devices or modifying the vehicle.

According to one aspect of the present embodiments, a vehicle control system controls a yaw motion of a subject vehicle generated by an operation of an input unit of a steering system of the subject vehicle. The vehicle control system includes: a yaw motion control unit that acquires information on a vehicle speed of a subject vehicle, an operable range of an input unit by a driver of the subject vehicle, and an operation amount of the input unit, calculates an addition amount which is an operation amount to be added to the operation amount reflecting the operable range, and outputs a calculated addition amount to a steering system.

According to another aspect of the present embodiments, a vehicle control system controls a yaw motion of a subject vehicle generated by an operation of an input unit of a steering system of the subject vehicle. The vehicle control system includes: at least one of (i) a circuit and (ii) a processor having a memory storing computer program code. The at least one of the circuit and the processor having the memory is configured to cause the vehicle control system to: acquire information on a vehicle speed of a subject vehicle, an operable range of an input unit by a driver of the subject vehicle, and an operation amount of the input unit; calculate an addition amount which is an operation amount to be added to the operation amount reflecting the operable range; and output a calculated addition amount to a steering system.

These vehicle control system is equipped with the yaw motion control unit that acquires the information on the vehicle speed of the subject vehicle, the operable range of the input unit in the steering system by the driver and the operation amount of the input unit, calculates the addition amount to be added to the operation amount taking into account the operable range, and outputs the addition amount to the steering system. This vehicle control system acquires the operable range of the driver, and thereby specifies the range of operable amounts of the input unit in the steering system according to the presence or absence of physical limitations of the driver. Then, the addition amount to be added to the operation amount is calculated based on the vehicle speed, the operable range, and the operation amount, and the addition amount is output to the steering system, so that the addition amount according to the driver's steering ability is added to the operation amount in the steering system. This results in a vehicle control system that is capable of appropriately controlling the yaw motion of the vehicle, regardless of the physical condition of the driver, without requiring any modifications to the vehicle.

According to another aspect of the present embodiments, a vehicle control program is executed by a yaw motion control device that controls a yaw motion of a subject vehicle generated by an operation of an input unit in a steering system of the subject vehicle.

The vehicle control program includes: a process of setting an operable range of the input unit by a driver of the subject vehicle; a process of calculating a yaw motion target value, which is a target value for realizing the yaw motion of the vehicle, based on information on the vehicle speed of the subject vehicle acquired by the yaw motion control device, information on the operation amount of the input unit by the driver, and the set operable range; and a process of calculating an addition amount to be added to the operation amount based on the yaw motion target value, the operable range, and the operation amount, the addition amount being output to the steering system in addition to the operation amount.

This vehicle control program includes a process for setting the operable range of the input unit in the steering system by the driver of the subject vehicle, thereby specifying the operable amount of the input unit depending on whether or not the driver has physical limitations. In addition, the program includes a calculation process of the yaw motion target value for realizing the yaw motion of the subject vehicle based on information on the vehicle speed, the operation amount of the input unit, and the set operable range, and a calculation process of an addition amount to be added to the operation amount, so that the addition amount according to the driver's steering ability is calculated. Therefore, this vehicle control program enables appropriate control of the yaw motion of the vehicle without any modification to the vehicle and regardless of the physical condition of the driver.

The reference numerals in parentheses attached to the components and the like indicate an example of correspondence between the components and the like and specific components and the like in an embodiment to be described below.

Embodiments of the present disclosure will be described below with reference to the drawings. In the following embodiments, the same or equivalent parts are denoted by the same reference numerals.

### Embodiments

A vehicle control system according to an embodiment will be described.

Hereinafter, the vehicle control system according to the embodiment will be referred to as “the vehicle control system”, and a vehicle such as an automobile on which the vehicle control system is mounted will be referred to as “a subject vehicle V”. In this embodiment, the vehicle control system will be described as being mounted on an automobile as a representative example, but the present embodiment is not limited to this feature and can also be applied to a moving body in which a yaw motion occurs due to the driver's operation.

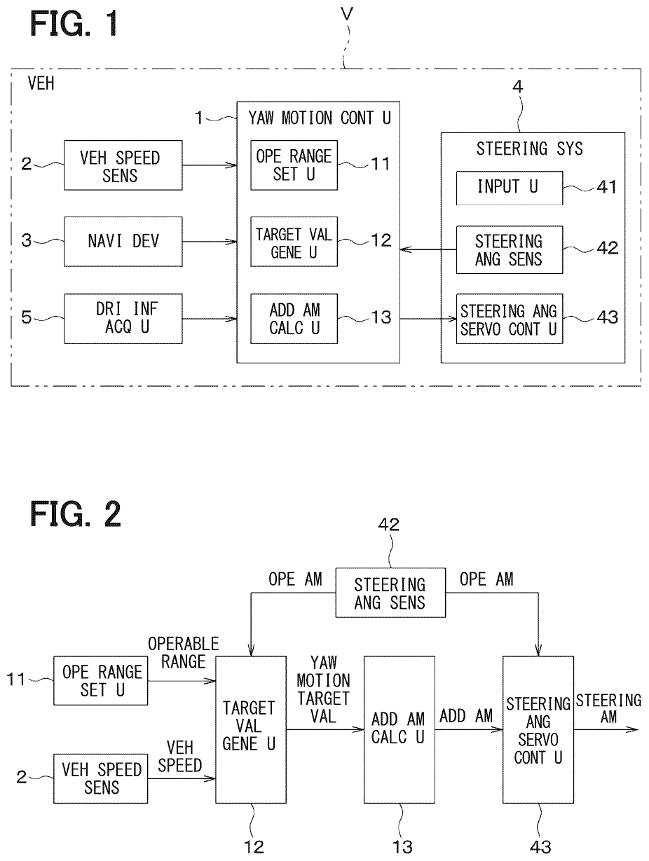

A subject vehicle V on which this vehicle control system is mounted includes, for example, a yaw motion control unit 1, a vehicle speed sensor 2, a navigation device 3, a steering system 4, and a driver information acquisition unit 5, as shown in FIG. 1. This vehicle control system is mainly executed by a yaw motion control unit 1.

The yaw motion control unit 1 is, for example, an electronic control unit in which various electronic components such as a CPU, ROM, and RAM are mounted on a circuit board (not shown), and is configured as an in-vehicle microcomputer, that is, an ECU. CPU, ROM, RAM, and ECU are abbreviations for Central Processing Unit, Read Only Memory, Random Access Memory, and Electronic Control Unit, respectively. The yaw motion control unit 1 has, for example, an operation range setting unit 11, a target value generation unit 12, and an addition amount calculation unit 13. The yaw motion control unit 1 corresponds to a yaw motion control device of the subject vehicle V, and is configured to realize the yaw motion control function of the embodiment, for example, by reading and executing a computer program stored in a storage medium (not shown) mounted on the subject vehicle V.

The storage medium in which the vehicle control program according to the embodiment is stored includes at least a ROM or a non-volatile rewritable memory among various non-transitory tangible storage medium such as a ROM or a non-volatile rewritable memory. The non-volatile rewritable memory is a storage device, such as a flash memory, which stores information to be rewritable while the power supply is in the on state, but stores the information to be non-rewritable while the power supply is in the off state.

The operation range setting unit 11 sets the operable range of the input unit 41 in the steering system 4 that can be operated by the driver of the subject vehicle V. The operable range varies depending on, for example, the design of the steering system 4 and the presence or absence of physical limitations of the driver, and is set for each driver. The operable range is set, for example, as a range from zero to an upper limit value based on the upper limit value of the amount of operation by the driver in an input operation of the input unit 41 or an equivalent device. For example, if the driver has some kind of physical limitations, the upper limit of the amount of operation by the driver may be smaller than the upper limit of the amount of operation designed for the input unit 41, and the operable range may be more limited than the original designed operable range. The operation range setting unit 11 may, for example, require the driver to operate the input unit 41 of the steering system 4 in advance before driving, and set the operable range based on information on the amount of operation acquired from the input unit 41 or the steering angle sensor 42. In addition, the operation range setting unit 11 may, for example, acquire data on the results, obtained by requiring the driver to perform preliminary operations to measure the operable range in a location other than the vehicle V, from a terminal device such as a smartphone, and set the operable range based on the data.

The target value generation unit 12 generates a yaw motion target value for controlling the yaw motion of the subject vehicle V so that the yaw motion of the subject vehicle V is within the operable range and in accordance with the amount of operation by the driver. The yaw motion target value is, for example, a yaw rate used to control the yaw angle of the subject vehicle V by the steering system 4. As shown in FIG. 2, the target value generation unit 12 acquires information such as the driver's operable range from the operation range setting unit 11, the vehicle speed from the vehicle speed sensor 2, and the operation amount of the input unit 41 from the steering angle sensor 42, and generates a yaw motion target value based on this information. The generation of the yaw motion target value will be described later in detail.

For example, when controlling the vehicle V to perform a target yaw motion based on the yaw motion target value generated by the target value generation unit 12, if the actual operation amount of the input unit 41 by the driver is insufficient, the addition amount calculation unit 13 calculates the shortfall as an addition amount. The addition amount calculation unit 13 outputs, for example, a signal corresponding to the calculated addition amount to the steering angle servo control unit 43. The signal output by the addition amount calculation unit 13 is used for the yaw motion control of the vehicle V, together with, for example, a signal output by the input unit 41 or the steering angle sensor 42 to a steering angle servo control unit 43 in response to the amount of operation by the driver. The calculation of the addition amount will be described later.

The vehicle speed sensor 2 acquires vehicle speed information of the subject vehicle V and outputs a detection signal corresponding to the vehicle speed of the subject vehicle V. A detection signal from the vehicle speed sensor 2 is input to, for example, the yaw motion control unit 1 and used for the yaw motion control. Here, FIG. 1 shows an example of a configuration in which the vehicle speed information of the subject vehicle V is acquired from a vehicle speed sensor 2, but the configuration is not limited to this feature, and the configuration may also be such that the vehicle speed information is acquired from a wheel speed sensor or another ECU to which the vehicle speed information is input.

The navigation device 3 outputs a video signal indicating the current position of the vehicle V, a map image, and the like to a video display unit (not shown) of the vehicle V based on map information stored in a map database, for example. The navigation device 3 acquires information regarding the latitude, longitude, current time, and the direction in which the vehicle is facing, for example, using a well-known GPS. The GPS is an abbreviation for Global Positioning System. The navigation device 3 is also used for outputting a video signal corresponding to operation navigation for setting an operable range in the operation range setting unit 11, for example.

The steering system 4 corresponds to a steering device of the subject vehicle V. The steering system 4 includes, for example, an input unit 41, a steering angle sensor 42, and a steering angle servo control unit 43. The steering system 4 is, for example, a steering-by-wire (i.e., SBW) system in which the input unit 41 and the tires of the vehicle V are not mechanically connected, but are connected by electrical signals, and the angle of the tires is controlled by the electrical signals. SBW, also known as steer-by-wire, is an electromechanical steering system that controls the angle of the tires using electrical signals.

The input unit 41 is a steering device used to operate the steering wheel of the subject vehicle V. The input unit 41 is, for example, a steering wheel, and in the case of the SBW system, the input unit 41 outputs a signal corresponding to the rotation angle of the steering wheel, i.e., the amount of operation, to the steering angle servo control unit 43 and is used to control the angle change of the tires of the vehicle V and the direction of travel of the vehicle V. The input unit 41 may not be limited to a steering wheel, but may be any device that can be operated to control the direction of travel of the vehicle V, and may be, for example, another known steering device such as a joystick.

The steering angle sensor 42 is disposed, for example, in the vicinity of the input unit 41, and detects the steering angle of the input unit 41, that is, the amount of operation, and outputs a signal corresponding to the detected steering angle. The output signal from the steering angle sensor 42 is input to, for example, the target value generation unit 12 and the steering angle servo control unit 43, and is used to generate a yaw motion target value and to control the yaw angle of the subject vehicle V. Although FIG. 1 shows a typical example of a steering system in which the input unit 41 is a steering wheel, the present embodiment is not limited to this feature. For example, if the input unit 41 is a joystick, the steering system 4 may have, instead of the steering angle sensor 42, an operation amount sensor that detects the amount of operation of the joystick. In other words, the steering angle sensor 42 is an example of an operation amount sensor of the input unit 41, and can be appropriately changed depending on the structure of the input unit 41.

The steering angle servo control unit 43 outputs an electrical signal corresponding to the yaw motion target value to an electromechanical actuator (not shown) that controls the angle of the tires of the subject vehicle V, for example. The steering angle servo control unit 43 is a control device used to cause the subject vehicle V to perform the yaw motion according to the yaw motion target value generated by the target value generation unit 12. The steering angle servo control unit 43 outputs an electrical signal corresponding to the steering amount to an actuator (not shown) based on, for example, information on the operation amount input from the input unit 41 or the steering angle sensor 42 and information on the addition amount input from the addition amount calculation unit 13. The steering amount referred to here means the output amount to an actuator that is operated to achieve a yaw motion target value. For example, in the case of a driver without physical limitations, the steering amount corresponds to the actual amount of operation of the input unit 41, and in the case of a driver with physical limitations, the steering amount corresponds to the amount obtained by adding the addition amount to the actual amount of operation.

The driver information acquisition unit 5 is a device that acquires driver information using any method. The driver information acquisition unit 5 may be, for example, an input device that allows the driver to input his or her own information, or the driver information acquisition unit may be an electronic information device that acquires driver information data from any electronic device in which driver information is stored, and acquires driver information for each driver. The acquired driver information is output to, for example, the yaw motion control unit 1 and linked to the operable range set by the operation range setting unit 11.

The above features are examples of the configuration of the subject vehicle V equipped with this vehicle control system.

### [Generation of Yaw Motion Target Value]

Next, generation of the yaw motion target value will be described. As described above, the target value generation unit 12 generates a yaw motion target value for controlling the yaw motion of the subject vehicle V in accordance with the vehicle speed of the subject vehicle V, the operable range and operation amount of the input unit 41 in the subject vehicle V. Specifically, the target value generation unit 12 calculates, for example, a first target yaw rate Yr_{tgt1} based on the following expression (1) which corresponds to the case where the vehicle speed of the subject vehicle V is low, and a second target yaw rate Yr_{tgt2} based on the following expression (2) which corresponds to the case where the vehicle speed is medium to high. Then, the target value generation unit 12 determines the smaller of the first target yaw rate Yr_{tgt1} and the second target yaw rate Yr_{tgt2} as the yaw motion target value.

Here, “low speed” and “medium/high speed” are classified according to the vehicle speed at which a lateral G force of a certain level or more is generated in the subject vehicle V, for example, whether the vehicle speed exceeds 20 km/h, but the threshold value can be changed as appropriate depending on the design of the subject vehicle V. When the threshold value is 20 km/h, a vehicle speed of 0 to 20 km/h corresponds to a low speed, and a vehicle speed exceeding 20 km/h corresponds to a medium to high speed.

$$\begin{matrix}( Expression 1 ) & \\ {Yr}_{tgt 1} = {κ}_{Max} \cdot \frac{L}{{δ}_{{MA}_{max}}} {G}_{γ f} \cdot {δ}_{MA} & ( 1 )\end{matrix}$$

The first target yaw rate Yr_{tgt1} calculated by the expression (1) corresponds to a case where the subject vehicle V is not affected by the lateral G caused by the yaw motion. K_{Max} in the expression (1) is the minimum curvature in vehicle performance, that is, the minimum turning radius that the subject vehicle V can achieve, and is a fixed value determined by the design of the subject vehicle V. θ_{MAmax} in the expression (1) is the operable range, that is, the maximum range in which the driver can operate the input unit 41 used to the steering operation of the vehicle V, and differs for each driver. δ_{MAmax} varies greatly depending on the presence or absence of physical limitations due to some kind of disability or injury or disease in the upper limbs of the driver. In the expression (1), L is the vehicle wheelbase, i.e., the length between the axles of the front and rear wheels when the vehicle V is viewed from the side, and is a fixed value determined according to the design of the vehicle V·G_{γf} in the expression (1) is the base vehicle yaw gain, that is, the magnitude of the angular velocity of the yaw angle per steering angle of the steering wheel of the subject vehicle V. In the expression (1), δ_{MA} is the amount of operation of the input unit 41 of the steering system 4 by the driver of the subject vehicle V.

$$\begin{matrix}( Expression 2 ) & \\ {Yr}_{tgt 2} = \frac{{G}_{ymax}}{{V}^{2}} \cdot \frac{L}{{δ}_{{MA}_{max}}} ( 1 + {K}_{st} {V}^{2} ) {G}_{γ f} \cdot {δ}_{MA} & ( 2 )\end{matrix}$$

The second target yaw rate Yr_{tgt2} calculated using the expression (2) corresponds to the case where the vehicle V is affected by the lateral G due to the yaw motion, and is a numerical target value that does not exceed, for example, the lateral G generated in the vehicle V at a normal driving speed. The normal driving speed means a vehicle speed in a general area that corresponds to the legal speed limit of the road, in other words, a vehicle speed in a normal driving range. In the expression (2), V is the vehicle speed of the subject vehicle V·G_{ymax} in the expression (2) is the set maximum lateral G output, i.e., the lateral G (i.e., centrifugal acceleration) generated in the vehicle V when the steering angle of the vehicle V is at its maximum output, and is a constant value determined according to the design of the vehicle V. Here, “steering angle is the maximum output” means the maximum amount of steering angle that occurs when the amount of operation of the input unit 41 of the subject vehicle V is the maximum amount of operation in design. In the expression (2), Kₛₜ is a vehicle stability factor, that is, a coefficient representing the steering characteristics of the subject vehicle V when turning, and is a constant value determined according to the design of the subject vehicle V.

Here, among the various parameters in the above expressions (1) and (2), those that do not change and remain constant are stored in advance, for example, in a storage medium installed in the vehicle V, and are read and used in necessary situations, such as generating a yaw motion target value.

The target value generation unit 12 calculates, for example, the first and second target yaw rates Yr_{tgt1}, Yr_{tgt2} regardless of the vehicle speed, and generates a yaw motion target value. This is because the target yaw rate is affected by δ_{MAmax}, as shown in the expressions (1) and (2). In the case of this calculation method, the yaw motion target value can also be said to be a yaw rate that is inversely proportional to the maximum value of the operable range. The yaw motion target value generated by the target value generation unit 12 is output to the addition amount calculation unit 13 and used to calculate the addition amount.

Here, the target value generation unit 12 may take into account the available response time of the subject vehicle V to the yaw rate control, i.e., the response performance, and may provide dynamics so as to satisfy the response performance when generating the yaw motion target value. In this case, the yaw motion control is executed for the subject vehicle V so that the yaw motion of the subject vehicle V gradually approaches the yaw motion target value within a predetermined time.

Further, the target value generation unit 12 may generate the yaw motion target value by a calculation method using a target steering gear ratio Nᵥ that takes δ_{MAmax} into consideration, instead of the above calculation method. Specifically, when the target steering gear ratio at low speed is defined as Nᵥ₁ and the target steering gear ratio at medium to high speed is defined as Nᵥ₂, Nᵥ₁ and Nᵥ₂ can be expressed by the following expressions (3) and (4). The target steering gear ratio is the ratio of the amount of change in the angle of the tires of the vehicle V with respect to the amount of input to the target steering device, and is a value determined according to the design of the vehicle V.

$$\begin{matrix}( Expression 3 ) & \\ {N}_{V 1} = \frac{1}{{κ}_{Max}} \cdot \frac{1}{L} {δ}_{{MA}_{max}} & ( 3 )\end{matrix}$$

$$\begin{matrix}( Expression 4 ) & \\ {N}_{V 2} = \frac{1}{{G}_{ymax}} \cdot \frac{1}{( 1 + {K}_{s t} {V}^{2} )} \cdot \frac{{V}^{2}}{L} {δ}_{{MA}_{max}} & ( 4 )\end{matrix}$$

The target steering gear ratio Nᵥ can be selected for each vehicle speed, for example, as expressed by the following expression (5). Thus, the yaw rate gains are acquired such that the minimum curvature Kₘₐₓ is taken into account at low speeds and the maximum lateral G output G_{ymax} is taken into account at medium to high speeds. In the expression (5), N S is the base steering gear ratio.

$$\begin{matrix}( Expression 5 ) & \\ {N}_{V} = min ( max ( {N}_{V 1} , {N}_{V 2} ) , {N}_{s} ) & ( 5 )\end{matrix}$$

The target steering gear ratio Nᵥ may be set by previously calculating a value according to the maximum operable range δ_{MAmax} by the driver and the vehicle speed, and selecting the value using a look-up table method. In this case, the target yaw rate Yr_{tgt} is calculated by the following expression (6) using the low-speed and medium-high-speed target steering gear ratios Nᵥ.

$$\begin{matrix}( Expression 6 ) & \\ {Yr}_{tgt} = \frac{1}{{N}_{V}} \cdot \frac{1}{( 1 + {K}_{s t} {V}^{2} )} \cdot \frac{V}{L} {δ}_{MA} & ( 6 )\end{matrix}$$

In this manner, the target value generation unit 12 may generate the target yaw rate Yr_{tgt} calculated based on the target steering gear ratio Nᵥ as the yaw motion target value. The portion of the right side of the expression (6) excluding δ_{MA} corresponds to an optimal steady-state yaw rate gain model that takes into account the target steering gear ratio Nᵥ at low speeds and medium to high speeds.

### [Calculation of the Amount of Addition]

Next, a configuration example of the addition amount calculation unit 13 and calculation of the addition amount will be described.

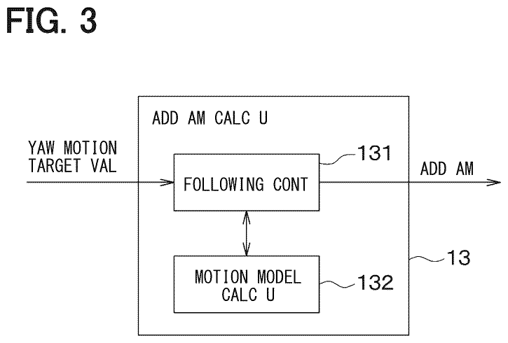

The addition amount calculation unit 13 includes, for example, a following controller 131 and a motion model calculation unit 132 as shown in FIG. 3.

The following controller 131 calculates an addition amount for matching the yaw motion target value from the target value generation unit 12 with the yaw rate calculated by the motion model calculation unit 132. For example, the following controller 131 calculates the yaw rate Yr1 acquired from the actual amount of operation of the input unit 41 by the driver based on a mathematical model equation and predetermined parameters acquired from the vehicle V (such as vehicle speed and amount of operation of the input unit 41). The following controller 131 then calculates, for example, the difference between the yaw motion target value and the yaw rate Yr1, and calculates an addition amount that is an insufficient amount of operation required to compensate for the difference. In other words, when the driver has physical limitations for some reason and the actual operation amount is insufficient for the yaw motion target value, the addition amount calculation unit 13 is configured to calculate an addition amount to compensate for the insufficient amount, that is, an operation addition amount, and output the calculated addition amount to the steering system 4.

The motion model calculation unit 132 adapts to, for example, the design of the vehicle V and the steering system 4, and calculates the yaw rate and vehicle body slip angle of the vehicle V based on predetermined input information such as the vehicle speed and the steering operation amount. The mathematical model adapts to, for example, an input to an actuator (not shown) used for steering control of the subject vehicle V, and is stored in a storage medium (not shown) in the steering system 4. The mathematical model adapts to various methods used for the yaw motion control, such as front steering, rear steering, DYC moment, and torque vectoring, and can be modified as appropriate depending on the design of the subject vehicle V. DYC is an abbreviation for Direct Yaw-moment Control. The motion model calculation unit 132 outputs, for example, a signal corresponding to the yaw rate calculated by the mathematical model to the following controller 131.

As described above, the addition amount calculation unit 13 stores a mathematical model of the vehicle V inside the system, and calculates an addition amount that matches the target value of the yaw rate corresponding to the operation amount with the value of the yaw rate calculated by the mathematical model. As a result, the yaw motion control of the subject vehicle V is performed similar to feedforward control, making it possible to acquire the actual vehicle yaw rate using a sensor and achieve more stable yaw motion control compared to a control method based on the output value of the sensor. This is because in the latter control method, when the yaw rate is directly acquired by the sensor, noise may be superimposed on the sensor output value, whereas the method of this vehicle control system uses a mathematical model for control, reducing the effects of noise.

Here, the addition amount calculation unit 13 calculates the addition amount regardless of the operable range, for example. For example, when the upper limit value of the operation amount in the design of the input unit 41 matches the upper limit value of the driver's operable amount, and the target yaw motion value based on the operation amount approximately matches the yaw rate based on the mathematical model, the addition amount to be added to the operation amount is calculated as zero.

### [Yaw Motion Control]

Next, an example of the processing operation in the yaw motion control by this vehicle control system will be described.

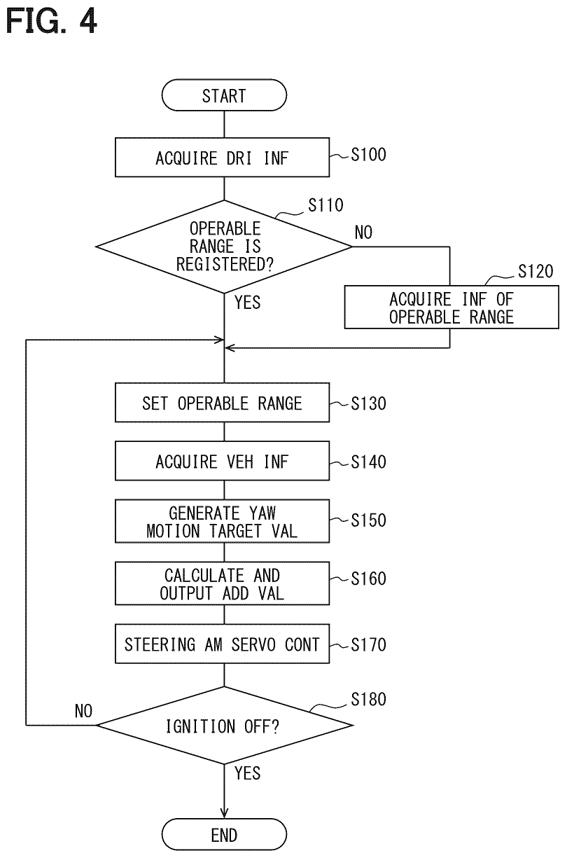

This vehicle control system executes the control flow shown in FIG. 4 when a predetermined start condition is satisfied, for example, when the ignition of the subject vehicle V is turned on. This vehicle control system realizes the control flow of FIG. 4, for example, by reading a computer program stored in a storage medium of the subject vehicle V and executing the computer program on an in-vehicle microcomputer.

In step S100, for example, the driver information acquisition unit 5 acquires driver information of the subject vehicle V. For example, the driver may input his/her own information or select the contents of pre-registered driver information, or the driver information may be acquired from an IC chip or information terminal on which the driver information is stored, but any other method may also be used.

In step S110, for example, the yaw motion control unit 1 determines whether or not the operable range of the input unit 41 corresponding to the driver information acquired in step S100 has been registered. For example, if the determination in step S110 is positive, the yaw motion control unit 1 advances the process to step S130, and if the determination in step S110 is negative, the yaw motion control unit 1 advances the process to step S120.

In step S120, for example, the operation range setting unit 11 acquires information on the operable range of the input unit 41 by the driver, in particular, the upper limit value of the operation amount. For example, the operation range setting unit 11 acquires information about the operable range by any method, such as by the driver's prior operation of the input unit 41 of the vehicle V as described above, or by acquiring data about the operable range acquired in advance at another location. This operable range is associated with the driver information acquired in step S100 and registered in a storage medium (not shown) of the vehicle control system.

In step S130, for example, the operation range setting unit 11 sets an operable range corresponding to the driver of the subject vehicle V. For example, if the determination in step S110 is positive, the operation range setting unit 11 sets the operable range based on the data of the operable range associated with the driver information. For example, if the determination in step S110 is negative, the operation range setting unit 11 sets the operable range based on the data of the operable range acquired in step S120. Step S130 corresponds to the process of setting the operable range in the vehicle control program according to the embodiment.

In the next step S140, for example, the yaw motion control unit 1 acquires various vehicle information such as the vehicle speed of the subject vehicle V and the operation amount of the input unit 41 from various sensors and in-vehicle equipment mounted on the subject vehicle V.

In the next step S150, for example, the target value generation unit 12 calculates the yaw motion target value using the calculation method described above, based on predetermined parameters including the operable range set in step S130, the operation amount of the input unit 41, and the vehicle speed of the subject vehicle V. Information on the calculated yaw motion target value is output to, for example, the addition amount calculation unit 13. Step S150 corresponds to the process of calculating the yaw motion target value in the vehicle control program according to the embodiment.

In step S160, for example, the addition amount calculation unit 13 calculates an addition amount for matching the yaw rate corresponding to the operation amount with the yaw rate based on the mathematical model, based on the yaw motion target value generated in step S150 and the mathematical model corresponding to the design of the vehicle V. Information on the calculated addition amount is output to, for example, the steering angle servo control unit 43. Step S160 corresponds to the process of calculating an addition value in the vehicle control program according to the embodiment.

In step S170, for example, the steering angle servo control unit 43 outputs a drive signal to an actuator (not shown) of the steering system 4 based on the information on the operation amount of the input unit 41 acquired in step S140 and the addition amount calculated in step S160. This drive signal is, for example, an electrical signal that corresponds to a value acquired by adding an addition amount to an operation amount. As a result, a signal of a steering amount corresponding to the driver's steering ability is output to an actuator (not shown) of the steering system 4, so that the tire angle of the vehicle V becomes an angle required to achieve the target yaw motion value, and the yaw motion of the vehicle V is appropriately controlled.

In the final step S180, for example, the yaw motion control unit 1 determines whether or not the ignition of the subject vehicle V is in an off state. For example, if the determination in step S180 is positive, the yaw motion control unit 1 ends the process, and if the determination in step S180 is negative, the process returns to step S130. In step S180, any predetermined end condition corresponding to the state in which driving of the subject vehicle V has ended may be used, and the determination process may be based on an end condition other than the ignition being turned off.

The above feature is an example of the yaw motion control of the subject vehicle V by the vehicle control system.

According to this embodiment, the vehicle control system recognizes the operable range of the driver's steering operation at the input unit 41, sets a yaw motion target value based on the operation amount of the input unit 41, and adds the operation amount when the yaw rate calculated based on the operation amount is insufficient for the target value. This vehicle control system performs the steering control by adding an addition amount to the actual operation amount to achieve the yaw motion target value, even if the driver has some physical limitations and the operable range of the input unit 41 is more limited than the original design value. Therefore, even if the driver has physical limitations, the yaw motion of the vehicle V can be appropriately controlled.

In addition, a yaw motion target value is generated based on the operable range and the operation amount of the input unit 41, and an operation addition amount is added when there is a deviation between the yaw rate calculated by the operation amount and the mathematical model and the generated yaw motion target value, so that it is possible to execute the yaw motion control even in a case where the driver has no physical limitations.

Therefore, this vehicle control system can achieve appropriate control of the yaw motion of the vehicle V, regardless of the individual physical abilities of the driver, while using a common cockpit, without making any modifications to the input unit 41 of the vehicle V or introducing any auxiliary devices.

### OTHER EMBODIMENTS

Although the present disclosure has been made in accordance with the embodiments, it is understood that the present disclosure is not limited to such embodiments and structures. The present disclosure includes various modifications or deformations within an equivalent range. In addition, various combinations and forms, and further, other combinations and forms including only one element, or more or less than these elements are also within the scope and the scope of the present disclosure.

The yaw motion control unit 1 and the method thereof described in the present disclosure are realized by a dedicated computer provided by configuring a processor and a memory programmed to execute one or more functions embodied by a computer program. Alternatively, the yaw motion control unit 1 and the method described in the present disclosure may be implemented by a special purpose computer configured as a processor with one or more special purpose hardware logic circuits. Alternatively, the yaw motion control unit 1 and the method thereof described in the present disclosure may be implemented by a combination of (i) a special purpose computer including a processor programmed to execute one or more functions by executing a computer program and a memory and (ii) a special purpose computer including a processor with one or more dedicated hardware logic circuits. The computer program may also be stored on a computer-readable and non-transitory tangible storage medium as an instruction executed by a computer.

The constituent element(s) of each of the above embodiments is/are not necessarily essential unless it is specifically stated that the constituent element(s) is/are essential in the above embodiment, or unless the constituent element(s) is/are obviously essential in principle. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Further, in each of the embodiments described above, when referring to the shape, positional relationship, and the like of the components and the like, it is not limited to the shape, positional relationship, and the like, except for the case where the components are specifically specified, the case where the components are fundamentally limited to a specific shape, positional relationship, and the like.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a vehicle control system to perform functions” should be understood that (i) only the circuit can cause a vehicle control system to perform all the functions, (ii) only the processor can cause a vehicle control system to perform all the functions, or (iii) the circuit can cause a vehicle control system to perform at least one of the functions and the processor can cause a vehicle control system to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle control system for controlling a yaw motion of a vehicle generated by an operation of an input unit in a steering system of the vehicle, comprising:
a yaw motion control unit that acquires information on a vehicle speed of the vehicle, an operable range of the input unit by a driver of the vehicle, and an operation amount of the input unit, calculates an addition amount that is to be added to the operation amount according to the operable range, and outputs a calculated addition amount to the steering system.

2. The vehicle control system according to claim 1, wherein:
the yaw motion control unit includes:
an operation range setting unit that sets the operable range;
a target value generation unit that calculates a yaw motion target value, which is a target value for realizing a yaw motion of the vehicle, based on the information on the operation amount, the operable range, and the vehicle speed; and
an addition amount calculation unit that calculates a value of the addition amount based on the operable range and the yaw motion target value.

3. The vehicle control system according to claim 2, wherein:
the yaw motion target value is a yaw rate that is inversely proportional to a maximum value of the operable range or a target steering gear ratio.

4. The vehicle control system according to claim 1, further comprising:
at least one of (i) a circuit and (ii) a processor having a memory storing computer program code, wherein:
the at least one of the circuit and the processor having the memory is configured to cause the vehicle control system to provide at least one of: the yaw motion control unit.

5. A non-transitory computer readable storage medium comprising instructions being executed by a yaw motion control device that controls a yaw motion of a vehicle generated by an operation of an input unit in a steering system of the vehicle, wherein:
the instructions includes:
setting an operable range of the input unit by a driver of the vehicle;
calculating a yaw motion target value, which is a target value for realizing the yaw motion of the vehicle, based on information on a vehicle speed of the vehicle acquired by the yaw motion control device, information on an operation amount of the input unit by the driver, and a set operable range; and
calculating an addition amount to be added to the operation amount based on the yaw motion target value, the operable range, and the operation amount; and
the addition amount is to be added to the operation amount and is output to the steering system.

6. A vehicle control method executed by a yaw motion control device that controls a yaw motion of a vehicle generated by an operation of an input unit in a steering system of the vehicle, the vehicle control method comprising:
setting an operable range of the input unit by a driver of the vehicle;
calculating a yaw motion target value, which is a target value for realizing the yaw motion of the vehicle, based on information on a vehicle speed of the vehicle acquired by the yaw motion control device, information on an operation amount of the input unit by the driver, and a set operable range; and
calculating an addition amount to be added to the operation amount based on the yaw motion target value, the operable range, and the operation amount, wherein:
the addition amount is to be added to the operation amount and is output to the steering system.
